(19) United States
(12) Patent Application Publication
(10) Pub. No.: US 2010/0161468 A1
(43) Pub. Date: Jun. 24, 2010

(54) SYSTEMS AND METHODS FOR AUTHENTICATING PARTIES ENGAGING IN A FINANCIAL TRANSACTION

(76) Inventor: Justin A. Hickman, St. Charles, MO (US)

Correspondence Address: DANIEL M. FITZGERALD (21652);ARMSTRONG TEASDALE LLP, ONE METROPOLITAN SQUARE, SUITE 2600, ST. LOUIS, MO, 63102-2740, US

(21) Appl. No.: 12/338,823

(22) Filed: Dec. 18, 2008

(51) Int. Cl. G06Q 30/00

(52) U.S. Cl. 705/35

(57) ABSTRACT

A method for authenticating parties engaging in a financial transaction is provided. The parties using a remote input device in communication with a financial transaction payment system. The payment system is coupled to a database. The parties include a customer registered with the payment system. The method includes storing within the database an authentication sound selected by the customer and a unique identifier assigned to the customer, accessing the payment system by the customer using the remote input device to engage in the financial transaction, prompting the customer to input the unique identifier assigned to the customer to authenticate the customer to the payment system, and transmitting the authentication sound from the payment system to the input device for the customer to hear the authentication sound to authenticate the payment system to the customer.

### BACKGROUND OF THE INVENTION

The field of the invention relates generally to systems and methods for authenticating parties engaging in a financial transaction, and more particularly to systems and methods for authenticating a party requesting personally identifiable information from a holder of a financial transaction card, when the parties are remotely located from one another, to reduce the likelihood of fraud in such remote financial transactions.

Financial transaction cards have made great gains in the United States and worldwide as a means to attract financial accounts to financial institutions and, in the case of credit cards, as a medium to create small loans and generate interest income for financial institutions. Nonetheless, the financial transaction card industry is subject to certain well-known problems.

It is well-known that at least some persons will engage in illegal or potentially illegal activities relating to the use of financial transaction cards. Specifically, one person may steal a financial transaction card from another person and attempt to use the financial transaction card to purchase products, pay for services, or obtain cash. Such problems are not limited to credit cards. Other examples include debit cards, gift cards, stored value cards, and check cards. In Internet and telephone interactions, for example, physical possession of the financial transaction card is not needed. Rather, only the numbers associated with the financial transaction card, such as the account number, the expiration date, etc., are needed for remote interactions. While such remote interactions provide the convenience and accessibility necessary to compete in today's competitive market, the fact that a physical financial transaction card is not needed for certain interactions only amplifies the problems mentioned herein.

Through the advancement of modern communications, fraudulent financial transaction schemes are becoming more prevalent. Moreover, such fraudulent schemes are becoming more difficult to detect, especially in the area of telephonic or other remote communications where there is little or no personal interaction. Companies and individuals throughout the world have lost hundreds of billions of dollars due to such fraudulent schemes. In at least some cases, the parties involved in facilitating such transactions, namely the acquirer bank, the issuer bank, and the financial transaction card network, which is sometimes referred as an interchange, generally do not require the legal cardholder to pay for such fraudulent transactions. Such a requirement would likely result in the loss of goodwill and perhaps the loss of the legal cardholder as a customer. However, the fraudulent transactions are a loss to one or more of these entities. To limit these losses, as well as maintain consumer trust, preventing such fraudulent schemes has become increasingly important to many companies, especially in the financial transaction card industry.

At least one such known fraudulent scheme is referred to as phishing. Phishing is the attempt to acquire personally identifiable information (PII) from a customer or other identifying information by pretending to be a trusted entity, often in the financial services area, through electronic communication, such as e-mail, text message, instant messaging, or a forged website. PII includes information that can be used to identify a person uniquely and reliably, such as full names, telephone numbers, street addresses, e-mail addresses, Internet Protocol (IP) addresses, social security numbers, passport numbers, drivers license numbers, vehicle registration plate number, vehicle identification number, financial transaction card numbers, digital handles, user names, passwords, and/or PIN (personal identification number) numbers. PII also includes biometrics such as faces, fingerprints, hand geometries, hand veins, irises, retinas, DNA, signatures, voices, odors, and ear canals. Other identifying information includes common information that may not be as specific or could be more easily discovered such as city, state, or country of residence, age, gender, race, name of a school or an employer, mother's maiden name, spouse's name, children's names, pet's name, and year of birth. Phishing techniques include link manipulation, filter evasion and website forgery. The same techniques used in phishing, however, are not limited to fake websites and e-mail.

Vishing, or “voice” phishing, is one example of using phishing techniques through telephone communications. Many victims of vishing have been directed through e-mail, text message, telephone call, postal mail, or some other form of communication to call a telephone number regarding a financial transaction card account. For example, the communication from the fraudulent entity lures the victims to call a telephone number by claiming that there is a pending issue with the account that needs their immediate attention. To add to the illusion of authenticity, some fraudulent communications include warnings of phishing and other identity theft measures. Unfortunately, the victims assume that the telephone number is legitimate and that their interaction is with a trusted entity because the victims have initiated the telephone interaction. Moreover, these assumptions are supposedly verified when the victims are greeted with the name of the trusted entity. Under this false assumption, many victims provide their financial transaction card numbers, expiration dates, PIN numbers, card verification code numbers, and other PII to the schemers over the telephone in an effort to address the made up pending account issue.

There are many systems and methods for financial transaction card companies to verify that the person calling is the true cardholders Some examples include the use of an Automatic Number Identification (ANI) service, passwords, access cards, voice biometric systems, encrypted voice and data systems. Unfortunately, the customer is limited in systems and methods available to verify that the entity on the other end of the line is the trusted entity.

Accordingly, a need exists for a more reliable way to minimize fraud in remote financial interactions through identity authentication by mutual verification.

### BRIEF SUMMARY OF THE INVENTION

In one aspect, a method for authenticating parties engaging in a financial transaction is provided. A financial transaction payment system is coupled to a database. The parties include a customer registered with the payment system. The customer uses a remote input device in communication with the payment system. The method includes storing within the database an authentication sound selected by the customer and a unique identifier assigned to the customer, accessing the payment system by the customer using the remote input device to engage in the financial transaction, prompting the customer to input the unique identifier assigned to the customer to authenticate the customer to the payment system, and transmitting the authentication sound from the payment system to the input device for the customer to hear the authentication sound to authenticate the payment system to the customer.

In another aspect, a method for authenticating parties engaging in a financial transaction is provided. A financial transaction payment system is coupled to a database. The parties include a customer registered with the payment system. The customer uses a remote input device in communication with the payment system. The method includes performing a first authentication including receiving at the payment system a unique identifier entered by the customer with the input device and matching the entered unique identifier to data stored within the database wherein the unique identifier was previously assigned to the customer, performing a second authentication including transmitting from the payment system to the input device an authentication sound previously selected by the customer and stored in the database, and performing a third authentication including receiving at the payment system identifying information entered by the customer with the input device and matching the entered identifying information to data stored within the database.

In another aspect, a system for authenticating parties including a customer engaging in a financial transaction is provided. The system includes a remote input device, a database for storing information, and a payment system coupled to the database and the input device. The payment system is configured to store within the database an authentication sound selected by the customer and a unique identifier assigned to the customer, receive from the input device the unique identifier to authenticate the customer, and transmit the authentication sound to the input device for the customer to hear the authentication sound to authenticate the payment system to the customer.

In another aspect, a computer-readable storage medium storing one or more sequences of instructions for authenticating parties engaging in a transaction is provided. The instructions include storing within a database an authentication sound selected by a first party and a unique identifier assigned to the first party, receiving from an input device the unique identifier to authenticate the first party to a transaction computer system, and transmitting the authentication sound from the transaction computer system to the input device for the first party to hear the authentication sound to authenticate the transaction computer system to the first party.

### BRIEF DESCRIPTION OF THE DRAWINGS

FIG. 1 shows a block diagram of an exemplary system that can be utilized for securing remote interactions through interactive authentication and includes a server system connected to a plurality of client systems in accordance with the present invention;

FIG. 2 shows an expanded block diagram of the exemplary system of FIG. 1 and includes a server system connected to a plurality of client systems in accordance with the present invention;

FIG. 3 shows a flowchart for a known authentication process for telephonic transactions;

FIG. 4 shows a flowchart for a known authentication process for Internet transactions;

FIG. 5 shows a flowchart for implementing the basic steps necessary for practice of an exemplary process that can be utilized for establishing an authentication sound for securing remote interactions through interactive audial authentication;

FIG. 6 shows a flowchart for implementing the basic steps necessary for practice of an exemplary process that can be utilized for securing remote interactions through interactive audial authentication; and

FIG. 7 shows a flowchart for implementing the basic steps necessary for practice of an exemplary process that can be utilized for selecting an authentication sound to be associated with the account.

### DETAILED DESCRIPTION OF THE INVENTION

The methods and systems described herein relate to a financial transaction card payment system, such as a financial transaction card payment system using the MasterCard® interchange (MasterCard® is a registered trademark of MasterCard International Incorporated located in Purchase, New York). The MasterCard® interchange is a proprietary communications standard promulgated by MasterCard International Incorporated for the exchange of financial transaction data between financial institutions that have registered with MasterCard International Incorporated.

Described herein are exemplary embodiments of systems and processes for authenticating parties involved in a financial transaction, and more particularly to systems and methods for authenticating a party requesting personally identifiable information from a holder of a financial transaction card when the parties are remotely located from one another for reducing the likelihood of fraud in such remote financial transactions. As described herein, remote interactions, also referred to as remote financial transactions, include, but are not limited to, a customer contacting the card issuing bank or associated third party to (a) review a monthly statement or recent charges, (b) review other transaction histories, (c) pay a monthly bill, (d) inquire about a balance, (e) redeem rewards, and (f) contact a customer service representative. The processes and systems described herein facilitate reducing the likelihood that a customer will inadvertently disclose personal information, including financial transaction card information, to a questionable third party by providing an identifiable authentication sound selected by the customer when the customer contacts the third party and before the customer provides an amount of personal information that would allow a fraudulent third party to engage in fraudulent activity involving the customer's financial transaction card.

By authenticating the identity of each party involved in such remote transactions, the systems and methods described herein increase the likelihood that the respective parties are the proper parties. Such systems and methods provide the company at least some confidence that the person initiating the interaction is the registered cardholder, and provide the registered cardholder at least some confidence that the entity the registered cardholder is attempting to contact is the trusted, legal company. Once it is determined that a person attempting an interaction does not appear to be the registered cardholder or that the entity with whom the person is attempting to interact does not appear to be the trusted, legal company, either party in the interaction would then discontinue the interaction.

A technical effect of the systems and methods described herein include at least one of (a) registering a customer having an account with a multi-party payment card interchange, (b) providing a financial transaction payment system at the multi-party payment card interchange that includes a processing unit, an interactive voice response (IVR) unit (also known as an interactive voice recognition unit), and a database for storing personally identifiable information relating to customers, (c) enabling the customer to select or upload an authentication sound using an input device to be associated with the customer's account, (d) storing the authentication sound that is associated with the customer's account within the database at the multi-party payment card interchange along with a unique identification number assigned to the customer, (e) enabling the customer to remotely contact the financial transaction payment system using the input device for conducting a financial transaction, (f) prompting the customer to input the unique identification number using the input device in order for the financial transaction payment system to make a first authentication and to retrieve the customer's authentication sound from the database, wherein the first authentication includes the financial transaction payment system authenticating the customer as a registered cardholder, (g) transmitting the authentication sound to the customer using the IVR unit such that the customer can hear the authentication sound to make a second authentication, wherein the second authentication includes the customer authenticating the financial transaction payment system, (h) prompting the customer to input personally identifiable information using the input device in order for the financial transaction payment system to make a third authentication and to perform the customer's financial transaction, wherein the third authentication includes the financial transaction payment system further authenticating the customer as a valid and registered cardholder, and (i) performing the financial transaction for the customer.

In one embodiment, a computer program is provided, and the program is embodied on a computer readable medium and utilizes a Structured Query Language (SQL) with a user interface front-end for administration and a report generator. In an exemplary embodiment, the system is web enabled and is run on a business-entity intranet. In yet another embodiment, the system is fully accessed by individuals having an authorized access outside the firewall of the business-entity through the Internet. In alternative embodiments, the system is run on at least one of a Windows®, Macintosh®, UNIX®, and Linux® environments (Windows® is a registered trademark of Microsoft Corporation of Redmond, Wash.; Macintosh® is a registered trademark of Apple Inc. of Cupertino, Calif.; UNIX® is a registered trademark of The Open Group, Reading of Berkshire, United Kingdom; and Linux® is a registered trademark of Linus Torvalds of Portland, Oreg.). The application is flexible and designed to run in various different environments without compromising any major functionality.

The systems and processes are not limited to the specific embodiments described herein. In addition, components of each system and each process can be practiced independent and separate from other components and processes described herein. Each component and process also can be used in combination with other assembly packages and processes.

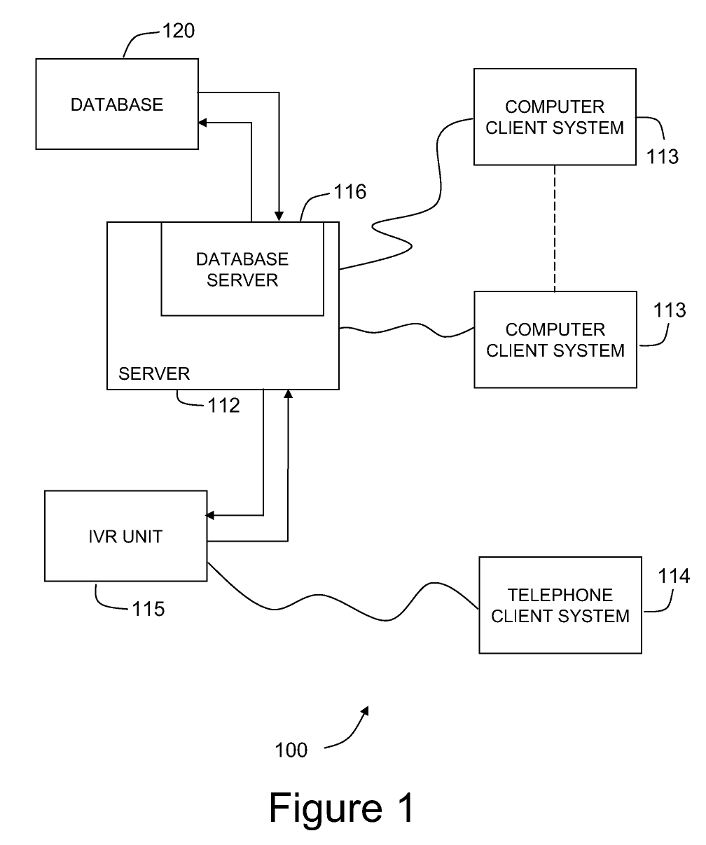

FIG. 1 is a simplified block diagram of an exemplary system 100 in accordance with one embodiment of the present invention. System 100 is the financial transaction card payment system that can be utilized for securing remote transactions through interactive authentication. More specifically, system 100 includes a server system 112 connected to a plurality of client systems 113, 114, also known as input devices. In one embodiment, client systems 113 are computers including a web browser, such that server system 112 is accessible to client systems 113 using the Internet. In another embodiment, client systems 114 are telephones such that server system 112 is accessible to client systems 114 over a telephone network or a cellular telephone network.

Computer client systems 113 could be connected to the Internet through many interfaces, including a network, such as a local area network (LAN) or a wide area network (WAN), dial-in-connections, digital subscriber lines (DSL), cable modems, and special high-speed ISDN lines. Computer client systems 113 could be any device capable of connecting to the Internet or any other device capable of connecting to server system 112 for transmitting and receiving sound data, including a web-based telephone, personal digital assistant (PDA), laptop computer, desktop computer, or other web-based connectable equipment.

Telephone client systems 114 could be communicatively connected to server system 112 through an interactive voice response (IVR) system 115, which is configured to process authentication sounds stored within database 120 and transmit such authentication sounds to telephone client systems 114 such that a user can hear the authentication sounds over telephone client systems 114. In an alternate embodiment, telephone client systems 114 could be communicatively connected to a human operator who has access to server system 112. In another alternate embodiment, telephone client systems 114 could be communicatively connected to server system 112 directly. In alternative embodiments, telephone client systems 114 can be a landline telephone, cellular telephone, handheld personal digital assistance, or any other device capable of communicating with server system 112.

A database server 116 is connected to database 120, which contains a variety of information including a name of the customer, an authentication sound, a unique identification number, a transaction history, and other personally identifiable information (PII) relating to customers. In one embodiment, database 120 is stored on server system 112 and can be accessed by users of client systems 113 and 114 by accessing the server system 112 through one of client systems 113 and 114. In an alternative embodiment, database 120 is stored remotely from server system 112. Furthermore, database 120 may be either centralized or non-centralized.

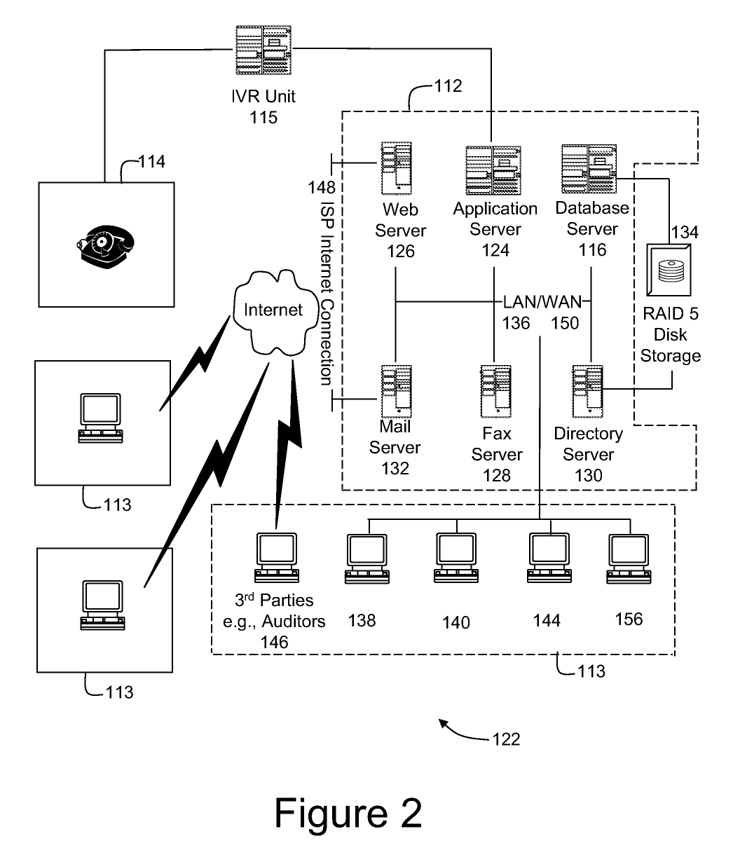

FIG. 2 is an expanded block diagram of an exemplary embodiment of a server architecture of system 122 in accordance with one embodiment of the present invention. Components in system 122, identical to components of system 100, are identified in FIG. 2 using the same reference numerals as used in FIG. 1. System 122 includes server system 112 and client systems 113, 114.

Server system 112 further includes database server 116, an application server 124, a web server 126, a fax server 128, a directory server 130, and a mail server 132. A disk storage unit 134 is coupled to database server 116 and directory server 130. Servers 116, 124, 126, 128, 130, and 132 are coupled in a LAN 136 or, in an alternative embodiment, in a WAN 150. Server system 112 is also coupled to interactive voice response (IVR) system 115.

A system administrator workstation 138, a user workstation 140, an employee workstation 144, and a manager workstation 156 are coupled to server system 112 through LAN 136. Alternatively, workstations 138, 140, 144, and 156 are personal computers coupled to LAN 136 using the Internet or an Intranet through web browsers. Workstations 138, 140, 144, and 156 are illustrated as being associated with separate functions only to facilitate an understanding of the different types of functions that can be performed by individuals having access to LAN 136. Such functions can be performed at one of many personal computers coupled to LAN 136. In alternative embodiments, workstations 138, 140, 144, and 156 can be telephone client systems 114 and be telephonically connected to server system 112.

Server system 112 is configured to be communicatively coupled to third parties 146, e.g., auditors, using an ISP Internet connection 148. In alternative embodiments, any other network communication, such as WAN 150 or LAN 136, can be utilized to communicatively couple third parties 146 to server system 112. In the exemplary embodiment, any authorized individual having a workstation 146 can access server system 112, including employees and managers.

In the exemplary embodiment, computer client systems 113 are connected to server system 112 through the Internet and LAN 136, and telephone client systems 114 are connected to server system 112 through an interactive voice response (IVR) system 115. In alternative embodiments, client systems 113 and 114 could be connected to server system 112 through many interfaces, such as those discussed above.

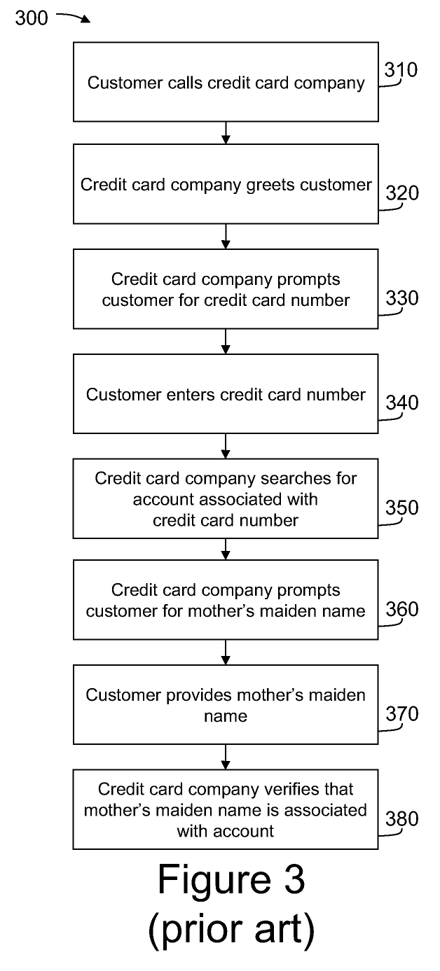

FIG. 3 is a flowchart 300 showing a known authentication process for telephonic transactions between a customer and a credit card company. A customer dials 310 a telephone number for a credit card company. The credit card company greets 320 the customer. In at least one known embodiment, the customer assumes that the telephone number is associated with the credit card company because the greeting included the company name. The credit card company prompts 330 the customer for at least some personally identifiable information (PII) of the customer. For example, the credit card company prompts the customer for a credit card number. In other known embodiments, the credit card company may prompt the customer for any PII that uniquely identifies the customer.

The customer either states or enters 340 the credit card number into an input device, and the credit card company searches 350 its database for an account that is associated with the credit card number. If the customer-provided credit card number is not found, the credit card company may prompt the customer to enter another credit card number. If the customer-provided credit card number is found, the credit card company prompts 360 the customer for other identifying information to verify the identity of the customer. For example, in one known embodiment, the credit card company prompts the customer for a mother's maiden name. In other known embodiments, the credit card company may prompt the customer for any identifying information that identifies the customer.

The customer provides 370 the mother's maiden name, and the credit card company searches 380 its database to verify that the mother's maiden name is associated with the account and the credit card number. If the customer-provided mother's maiden name is not associated with the account, the credit card company may cease and terminate the transaction. If the customer-provided mother's maiden name is associated with the account, the credit card company can be confident that the customer is a registered cardholder and allows the customer to continue the transaction. The customer, however, is never provided with secure identifying data from the entity on the other end of the telephone line and is not assured that the entity is the credit card company. In the case that the telephone number is not legitimately associated with the credit card company, the customer has disclosed some PII, including the credit card number and the mother's maiden name, to a questionable third party.

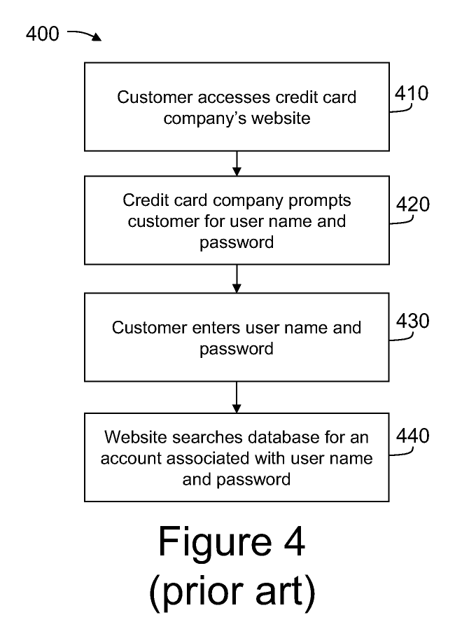

FIG. 4 is a flowchart 400 showing a known authentication process for Internet transactions between a customer and a credit card company. A customer accesses 410 a credit card company's website. In this known embodiment, the customer assumes that the website is associated with the credit card company because the website contains the company logo and at least appears to be legitimate. The website prompts 420 the customer for at least some PII and authenticating data that only the legal account holder should know. For example, the website prompts the customer for a user name and password. In other known embodiments, the website may prompt the customer for any PII that uniquely identifies the customer and any data that only the legal account holder such know, such as a PIN number.

The customer enters 430 the user name and password, and the website searches 440 its database for an account that is associated with the user name and password. If either the user name or password is not found, the website may prompt the customer to enter another user name and password. In at least one known embodiment, the website may limit the customer to a finite number of attempts before terminating the connection. If the customer-provided user name and password are found, the website can be confident that the customer is a registered cardholder and allows the customer to continue the transaction. The customer, however, is never provided with secure identifying data from the entity associated with the website and is not assured that the entity is the credit card company. In the case that the website is not legitimately associated with the credit card company, the customer has disclosed some PII, including the user name and password, to a questionable third party.

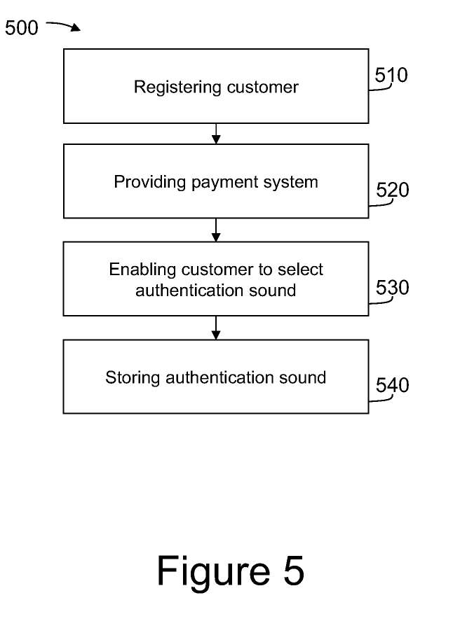

FIG. 5 is a flowchart 500 showing a registration process for establishing an authentication sound for remote transactions between a customer (also known as cardholder) and a transaction card company that addresses the problems described with the processes shown in FIGS. 3 and 4. In the example embodiment, the transaction card company includes at least one of an issuing bank and a multi-party payment card interchange. In alternative embodiments, the remote transactions are related to financial transaction cards requiring PII, such as credit cards and debit cards, and not requiring PII, such as gift cards.

The transaction card company registers 510 a customer having an account with the payment system. To register the customer and maintain the account, the transaction card company provides 520 a payment system that includes a processing unit, an interactive voice response (IVR) unit, and a database for storing personally identifiable information (PII) relating to customers or other identifiable information relating to the financial transaction card or account. In one embodiment, PII includes information that can be used to identify a person uniquely and reliably, such as full names, telephone numbers, street addresses, e-mail addresses, social security numbers, financial transaction card numbers, user names, passwords, and PIN numbers. Other identifying information that could be used to verify identify includes common information that may not be as specific, such as mother's maiden name, spouse's name, children's names, pet's name, and year of birth.

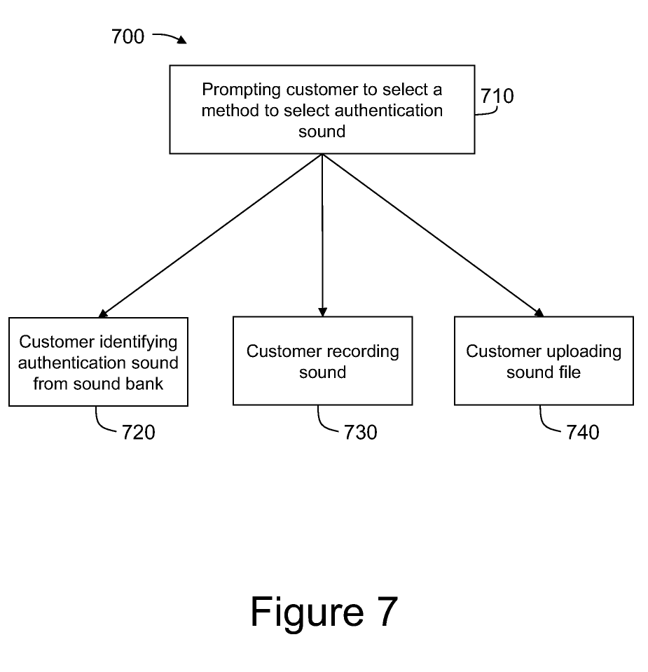

The transaction card company enables 530 the customer to select an authentication sound using an input device to be associated with the account. The customer makes this selection by accessing the payment system with the input device. Embodiments of selecting an authentication sound are provided in the description of FIG. 7. The payment system stores 540 the authentication sound that is associated with the customer's account within the database along with a unique identification number assigned to the customer. In alternative embodiments, the database is associated with at least one of an acquirer bank, an issuing bank and a financial transaction card network.

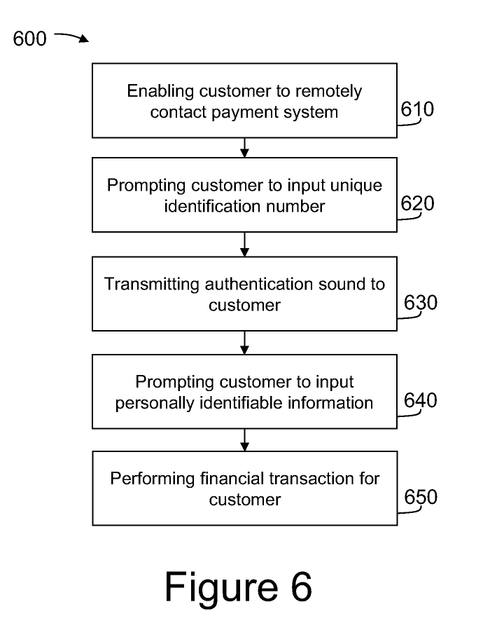

FIG. 6 is a flowchart 600 showing an authentication process for remote transactions between a customer (also known as cardholder) and a transaction card company that addresses the problems described with the processes shown in FIGS. 3 and 4. In the example embodiment, the authentication process is between the customer and the transaction card company using the authentication sound established in FIG. 5.

The transaction card company, via the payment system, enables 610 the customer to remotely contact the payment system using the input device for conducting a financial transaction. In one embodiment, a customer dials a telephone number for a financial transaction card company or accesses the payment system using a remote computer system. In alternative embodiments, the financial transaction card company can include at least one of an acquirer bank, an issuing bank and a financial transaction card network. The company, or, more specifically, the payment system associated with the financial transaction card company, greets the customer using Interactive Voice Response (IVR) system 115. In an alternative embodiment, the customer is greeted by a human operator with access to server system 112. In another alternative embodiment, a customer accesses the payment system through a website associated with the company. When accessing the payment system, the customer assumes that the telephone number or the uniform resource locator (URL) for the financial transaction card company is legitimate and that the interaction is with the trusted transaction card company.

The payment system then prompts 620 the customer to enter certain PII into an input device such as a telephone or computer system so that the payment system can at least initially identify the customer. This step serves as a first authentication. In one embodiment, the financial transaction card company prompts the customer for a unique identification number previously provided to the customer by the transaction card company, or selected by the customer and provided to the transaction card company. In alternative embodiments, the payment system may prompt the customer for any PII that uniquely identifies the customer, such as user name, telephone number, virtual card number different from the actual financial transaction card number, and a subset of the financial transaction card number, expiration date, and card verification code. In another alternative embodiment, the company may automatically acquire a unique number, such as a telephone number from which the customer is calling through using Automatic Number Identification (ANI), and immediately proceed to the next step without the customer entering a unique identifier. In yet another alternative embodiment, the company may prompt the customer for other identifiable information relating to the financial transaction card or account. The payment system uses the received unique identification number to verify the cardholder and to retrieve the cardholder's authentication sound.

If, however, the customer is prompted for a financial transaction card number rather than their unique number, the customer may cease interacting with that particular payment system, should terminate the transaction, and contact the customer service representative of the transaction card company through other means to get a new unique number. In such a situation, where the telephone number or the URL is not legitimately associated with the transaction card company, the customer has only disclosed the unique number to a questionable third party and can be assured that no private or sensitive data was shared.

The customer inputs the unique identification by either stating or enters the unique number into a touch-tone telephone, a computer, or input device, and the payment system searches its database for an account that is associated with the unique number. If the customer-provided unique number is not found, the payment system may prompt the customer to enter another unique number. In one embodiment, IVR system 115 or the website may limit the customer to a finite number of attempts. If the customer cannot input a unique number associated with an account within the finite number of attempts, IVR system 115 or the website may cease and terminate the transaction, disallowing any unauthorized access to an account.

If the customer-provided unique number is found, the payment system transmits 630 an authentication sound to the customer so that the customer knows that the payment system is associated with the legitimate transaction card company. This step serves as a second authentication. In one embodiment, the payment system transmits the authentication sound using the IVR. If the customer is not presented with the authentication sound or does not recognize the authentication sound, the customer may cease interaction with the payment system, should then terminate the transaction, and contact the customer service representative through other means to get a new unique number. In the case that the telephone number is not legitimately associated with the company, the customer has only disclosed the unique number to a questionable third party and can be assured that no private or sensitive data was shared. If the customer recognizes the authentication sound, the customer can be confident that the telephone number is legitimately associated with the transaction card company.

The payment system prompts 640 the customer for identifying information to verify the identity of the customer. This step serves as a third authentication. In alternative embodiments, the payment system may prompt the customer for any identifying information that identifies the customer or for any data that only the legal account holder such know. The customer enters the identifying information into a touch-tone telephone, a computer, or input device, and the company searches its database to verify that the identifying information is associated with the account. If the customer-provided identifying information is not associated with the account, the payment system may cease and terminate the transaction. If the customer-provided identifying information is associated with the account, the company can be confident that the customer is a legal customer and allows the customer to continue the transaction.

Once both parties are verified, the payment system performs 650 a financial transaction for the customer. In one embodiment, the customer can request that the company perform a variety of tasks including reviewing a monthly statement or recent charges, reviewing other transaction histories, paying a monthly bill, inquiring about a balance, redeeming rewards, and contacting a customer service representative.

FIG. 7 is a flowchart 700 showing a process for selecting an authentication sound to be associated with the account. In order for the authentication sound to be recognized by the customer as a verification of the company's identity, the customer selects the authentication sound prior to the transaction where the authentication sound is used as a mode of verification. There are several methods of selecting such an authentication sound. The payment system prompts 710 the customer to select which method the customer wants to use to select an authentication sound. The customer states or enters in an input device one of the following options.

In one embodiment, the customer wants to identify 720 an authentication sound from a plurality of sounds made available by the company. Each sound of a plurality of sounds could be associated with a number, and the customer would state or enter into the touch-tone telephone the number associated with the selected sound. For example, the company could present a first sound of a dog barking with the audial message, “To select sound 1, please state or enter ‘one,’” and present a second sound of a cat meowing with the audial message, “To select sound 2, please state or enter ‘two.’” In an alternate embodiment, the customer could select the file from a plurality of sounds provided at the company's website. The customer would then state or enter the appropriate number, one or two, into a touch-tone telephone, a computer, or input device to identify the sound as the selected authentication sound.

In another embodiment, the customer wants to record 730 an authentication sound. The customer provides a unique sound, and the payment system records the sound for future playback. For example, the customer could state any phrase, such as his or her own name in his or her own voice, over the telephone to be recorded by the company. There are numerous sounds and phrases the customer could provide, and the customer can be assured that the entity on the other end of the line is the card company when presented with the unique sound. In an alternate embodiment, the customer could provide the unique sound over a microphone attached to a personal computer, and the company could record the sound over the company's website. In another alternate embodiment, the company could limit the recording to a fixed amount of time.

In another embodiment, the customer wants to upload 740 an authentication sound at the company's website. The customer uploads a sound file of the customer's own choice over the Internet, and the company downloads the sound file for future playback. In alternative embodiments, the authentication sound could be an original recording, a file from a bank of clip art sounds, a ring tone, or a commercial recording. In alternative embodiments, the authentication sound could be any one of a plurality of formats, including, but not limited to, wav, ogg, mpc, flac, aiff, raw, au, mid, gsm, dct, vox, aac, mp4, m4a, mmf, mp3, wma, ra, dss, msv, dvf, and iklax.

While the embodiments described herein relate to authenticating parties engaged in a financial transaction, it should be understood by those skilled in the art that the systems and methods described herein could also be applicable to authenticating a party in numerous other types of transactions. Thus, the system and process described herein could also be applied to numerous other types of transactions wherein the parties are remotely located from one another, and the parties want to authenticate one another to reduce the likelihood of fraud.

While the invention has been described in terms of various specific embodiments, those skilled in the art will recognize that the invention can be practiced with modification within the spirit and scope of the claims. In addition, components of each system and each method can be practiced independent and separate from other components and methods described herein. Each component and method also can be used in combination with other assembly packages and processes.

What is claimed is:

1. A method for authenticating parties engaging in a financial transaction using a remote input device in communication with a financial transaction payment system, the payment system coupled to a database, the parties including a customer registered with the payment system, said method comprising:
storing within the database an authentication sound selected by the customer and a unique identifier assigned to the customer;
accessing the payment system by the customer using the remote input device to engage in the financial transaction;
prompting the customer to input the unique identifier assigned to the customer to authenticate the customer to the payment system; and
transmitting the authentication sound from the payment system to the remote input device for the customer to hear the authentication sound to authenticate the payment system to the customer.

2. A method in accordance with claim 1 further comprising:
registering the customer with the payment system by storing customer information within the database including a name, an account number and other identifying information; and
providing the unique identifier to the customer for accessing account information and performing financial transactions.

3. A method in accordance with claim 2 wherein the unique identifier includes at least one of a telephone number of the cardholder, a subset of a number associated with the account, a number involving an expiration date of a card associated with the account and a card verification code associated with the card, and a virtual card number that is not the same as a number associated with the card.

4. A method in accordance with claim 1 wherein storing within the database an authentication sound further comprises:
prompting the customer at the remote input device to select the authentication sound from a plurality of prerecorded authentication sounds stored within the database.

5. A method in accordance with claim 1 wherein storing within the database an authentication sound further comprises:
prompting the customer at the remote input device to create the authentication sound by speaking into the remote input device.

6. A method in accordance with claim 1 wherein storing within the database an authentication sound further comprises:
prompting the customer at the remote input device to transmit a prerecorded sound file from the remote input device to the payment system for storage within the database.

7. A method in accordance with claim 1 wherein the remote input device is a telephone associated with the customer and the unique identifier is a telephone number assigned to the telephone, and wherein said method further comprises:
automatically receiving the unique identifier at the payment system from the remote input device when the customer contacts the payment system; and
automatically transmitting the authentication sound from the payment system to the remote input device for the customer to hear the authentication sound to authenticate the payment system to the customer.

8. A method in accordance with claim 1 further comprising:
prompting the customer to input additional identifying information to authenticate the customer to the payment system; and
prompting the customer to perform the financial transaction via the payment system.

9. A method in accordance with claim 1 wherein the remote input device is at least one of a telephone and a computer system.

10. A method for authenticating parties engaging in a financial transaction using a remote input device in communication with a financial transaction payment system, the payment system coupled to a database, the parties including a customer registered with the payment system, said method comprising:
performing a first authentication including receiving at the payment system a unique identifier entered by the customer with the remote input device and matching the entered unique identifier to data stored within the database, wherein the unique identifier was previously assigned to the customer;
performing a second authentication including transmitting from the payment system to the remote input device an authentication sound previously selected by the customer and stored in the database; and
performing a third authentication including receiving at the payment system identifying information entered by the customer with the remote input device and matching the entered identifying information to data stored within the database.

11. A system for authenticating parties engaging in a financial transaction, the parties including a customer, wherein said system comprises:
a remote input device;
a database for storing information; and
a payment system coupled to said database and said remote input device, said payment system configured to:
store within said database an authentication sound selected by the customer and a unique identifier assigned to the customer,
receive from said remote input device the unique identifier to authenticate the customer, and
transmit the authentication sound to said remote input device for the customer to hear the authentication sound to authenticate said payment system to the customer.

12. A system in accordance with claim 11 wherein said payment system is further configured to register the customer with said payment system by storing customer information within said database including a name, an account number and other identifying information, and provide the unique identifier to the customer for accessing account information and performing financial transactions.

13. A system in accordance with claim 12 wherein the unique identifier includes at least one of a telephone number of the cardholder, a subset of a number associated with the account, a number involving an expiration date of a card associated with the account and a card verification code associated with the card, and a virtual card number that is not the same as a number associated with the card.

14. A system in accordance with claim 11 wherein said payment system is further configured to receive from said remote input device a selection of the authentication sound from a plurality of prerecorded authentication sounds stored within the database.

15. A system in accordance with claim 11 wherein said payment system is further configured to receive from said remote input device a recording of the authentication sound, wherein the recording includes the customer speaking into said remote input device.

16. A system in accordance with claim 11 wherein said payment system is further configured to receive from said remote input device a selection of the authentication sound, wherein the selection includes a prerecorded sound file.

17. A system in accordance with claim 11 wherein said remote input device is a telephone associated with the customer and the unique identifier is a telephone number assigned to the telephone, and wherein said payment system is further configured to automatically receive the unique identifier from said remote input device when the customer contacts said payment system, and automatically transmit the authentication sound to said remote input device for the customer to hear the authentication sound to authenticate said payment system to the customer.

18. A system in accordance with claim 11 wherein said payment system is further configured to receive additional identifying information to authenticate the customer to the payment system, and receive a request from said remote input device to perform the financial transaction via the payment system.

19. A system in accordance with claim 11 wherein said remote input device is at least one of a telephone and a computer system.

20. A computer-readable storage medium storing one or more sequences of instructions for authenticating parties engaging in a transaction, the instructions, when executed by one or more processors, cause the one or more processors to carry out the steps of:
storing within a database an authentication sound selected by a first party and a unique identifier assigned to the first party;
receiving from a remote input device the unique identifier to authenticate the first party to a transaction computer system; and
transmitting the authentication sound from the transaction computer system to the remote input device for the first party to hear the authentication sound to authenticate the transaction computer system to the first party.

21. A computer-readable storage medium in accordance with claim 20 wherein the instructions further cause the one or more processors to carry out the steps of:
registering the first party with the transaction computer system by storing first party information within the database including a name, an account number and other identifying information; and
providing the unique identifier to the first party for accessing account information and performing transactions.

22. A computer-readable storage medium in accordance with claim 21 wherein the first party is a transaction cardholder, and wherein the unique identifier includes at least one of a telephone number of the cardholder, a subset of a number associated with the account, a number involving an expiration date of a card associated with the account and a card verification code associated with the card, and a virtual card number that is not the same as a number associated with the card.

23. A computer-readable storage medium in accordance with claim 20 wherein storing within the database an authentication sound further comprises:
receiving from the remote input device a selection of the authentication sound from a plurality of prerecorded authentication sounds stored within the database.

24. A computer-readable storage medium in accordance with claim 20 wherein storing within the database an authentication sound further comprises:
receiving from the remote input device a recording of the authentication sound, wherein the recording includes the first party speaking into the remote input device.

25. A computer-readable storage medium in accordance with claim 20 wherein storing within the database an authentication sound further comprises:
receiving from the remote input device a selection of the authentication sound, wherein the selection includes a prerecorded sound file.

26. A computer-readable storage medium in accordance with claim 20 wherein the remote input device is a telephone associated with the first party and the unique identifier is a telephone number assigned to the telephone, and wherein the instructions further cause the one or more processors to carry out the steps of:
automatically receiving the unique identifier at the transaction computer system from the remote input device when the first party contacts the transaction computer system; and
automatically transmitting the authentication sound from the transaction computer system to the remote input device for the first party to hear the authentication sound to authenticate the transaction computer system to the first party.

27. A computer-readable storage medium in accordance with claim 20 wherein the instructions further cause the one or more processors to carry out the steps of:
receiving additional identifying information to authenticate the first party to the transaction computer system; and
receiving a request from the remote input device to perform the transaction via the transaction computer system.

28. A system in accordance with claim 20 wherein the remote input device is at least one of a telephone and a computer system.
